(19) United States
(12) Patent Application Publication
(10) Pub. No.: US 2025/0339251 A1
(43) Pub. Date: Nov. 6, 2025

(54) HAND-HELD DENTAL CLEANING APPARATUS

(71) Applicant: Goldenfish Industries, Inc., San Diego, CA (US)

(72) Inventors: Laureen Ryan, San Diego, CA (US); Richard Galinson, Toluca Lake, CA (US)

(73) Assignee: Goldenfish Industries, Inc., San Diego, CA (US)

(21) Appl. No.: 19/193,845

(22) Filed: Apr. 29, 2025

Related U.S. Application Data
(60) Provisional application No. 63/641,881, filed on May 2, 2024.

(51) Int. Cl. A61C 17/02; A61C 17/024

(52) U.S. Cl. CPC A61C 17/0202; A61C 17/0208; A61C 17/024

(57) ABSTRACT

A dental cleaning apparatus can include a handle and a head portion coupled to the handle. The head portion can include a body configured to be placed around at least one tooth and one or more spray ports or nozzles and one or more suction ports or nozzles coupled to or formed within the body. The one or more spray ports or nozzles can be configured to spray rinsing liquid on the at least one tooth, and the one or more suction ports or nozzles can be configured to remove discharge from a surface of the at least one tooth.

### CROSS-REFERENCE TO RELATED APPLICATION

This application claims the benefit of U.S. Provisional Patent Application No. 63/641,881, filed on May 2, 2024, which is incorporated by reference herein in its entirety.

### FIELD

The present disclosure relates to a hand-held dental cleaning apparatus.

### BACKGROUND

Dental cleaning apparatuses are commonly used to clean a person's teeth, gums, and tongue. Typically, a person applies toothpaste to the toothbrush. The person then brushes their teeth in an abrading motion to dislodge plaque, food, and other detritus, which is expelled with the toothpaste when the person rinses their mouth with and spits out rinsing liquid after brushing.

However, brushing can be difficult for ill, elderly, or disabled people. For example, patients in hospice or palliative care settings can suffer from debilitating diseases and lack sufficient strength to spit out toothpaste after brushing. Furthermore, elderly patients who lose the physical or mental ability to spit can have difficulty rinsing toothpaste from their mouths. Finally, stroke victims experiencing dysphagia can lose the ability to spit or swallow. Although a healthcare worker can help a person manipulate a toothbrush, the healthcare worker cannot easily help the person rinse out their mouth after brushing. For example, if the healthcare worker pours rinsing liquid into the person's mouth, the person can swallow or even choke on the rinsing liquid. Thus, there exists a need for a way to assist a healthcare worker in the rinsing of a person's mouth.

### SUMMARY

The present application discloses a dental cleaning apparatus in accordance with certain examples that can solve one or more deficiencies in the prior art. For example, the dental cleaning apparatus can include a head with a spray nozzle for spraying rinsing liquid onto a surface of a tooth (and/or onto a surface of a gum in which the tooth is embedded) and a vacuum nozzle for removing discharge and other detritus from the surface of the tooth (and/or from the surface of the gum).

In one representative example, a dental cleaning apparatus can include a handle and a head portion coupled to the handle. The head portion can include a body configured to be placed around at least one tooth and one or more spray nozzles and one or more suction nozzles coupled to or formed within the body.

In another representative example, a dental cleaning apparatus can include a handle portion and a head portion coupled to a distal end of the handle portion. The head portion can include a flexible body configured to enclose at least one tooth, a spray nozzle configured to spray rinsing liquid towards the at least one tooth, and a suction nozzle configured to draw discharge from the at least one tooth into the head portion.

In another representative example, a dental cleaning apparatus can include a handle portion, a head portion coupled to a distal end of the handle portion. The head portion can include a body configured to accommodate a tooth, a spray nozzle extending from a first interior surface of the body, and a suction nozzle extending from a second interior surface of the body. The spray nozzle can be configured to spray rinse water on the tooth. The suction nozzle can be configured to suction discharge from a surface of the tooth. The dental cleaning apparatus can further include a base unit in fluid communication with the spray nozzle, wherein the base unit is configured to pump rinsing liquid to the spray nozzle.

In a representative example, a head for a dental cleaning apparatus can include a flexible body configured to be placed around a tooth, a first nozzle, and a second nozzle. The flexible body can include a first wall, a second wall joined to the first wall, and a third wall joined to the first wall. The first nozzle can extend from an interior surface of the second wall. The second nozzle can extend from an interior surface of the third wall.

In a representative example, a dental cleaning apparatus can include a handle, a head portion coupled to the handle, wherein the head portion can include at least one spray port and at least one suction port, and a rim extending around the spray port and the suction port, wherein the rim can be an annular structure configured to be placed around at least a portion of a tooth.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a perspective view of a dental cleaning apparatus, according to one example.

FIG. 2A is a perspective view of a head for a dental cleaning apparatus, according to one example.

FIG. 2B is a side view of the head shown in FIG. 2A.

FIG. 2C is an end view of the head of FIG. 2A, shown placed over a tooth.

FIG. 3 is a perspective view of a head for a dental cleaning apparatus, according to another example.

FIG. 4 is a perspective view of a head for a dental cleaning apparatus, according to another example.

FIG. 5 is a perspective view of a tool portion of a dental cleaning apparatus, according to another example.

FIG. 6 is a perspective, cross-sectional view of the tool portion of the dental cleaning apparatus shown in FIG. 5

FIG. 7 is a perspective view of an inner body of the dental cleaning apparatus shown in FIG. 5.

FIG. 8 is a proximal end view of the tool portion of the dental cleaning apparatus shown in FIG. 5.

FIG. 9 is a distal end view of the tool portion of the dental cleaning apparatus shown in FIG. 5.

FIG. 10 is a side view of the tool portion of the dental cleaning apparatus shown in FIG. 5.

FIG. 11 is a top-down view of the tool portion of the dental cleaning apparatus shown in FIG. 5.

FIG. 12 is a side cross-sectional view of the tool portion of the dental cleaning apparatus taken along line 12-12 of FIG. 11.

FIG. 13 is a distal end cross-sectional view of the tool portion of the dental cleaning apparatus taken along line 13-13 of FIG. 11.

### DETAILED DESCRIPTION

### General Considerations

For purposes of this description, certain aspects, advantages, and novel features of examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved. The accompanying drawing figures referred to herein are representative, are not necessarily drawn to scale, and may be exaggerated to illustrate various aspects of the present disclosure. In this regard, the drawing figures should not be construed as limiting unless otherwise stated.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the term “coupled” generally means physically, mechanically, chemically, magnetically, and/or electrically coupled or linked and does not exclude the presence of intermediate elements between the coupled or associated items absent specific contrary language.

As used in this application and in the claims, the term “oral cavity” refers to a mouth of a patient. The oral cavity can comprise a first jawbone and a second jawbone. The first jawbone further can comprise a first plurality of teeth extending from the first jawbone towards the second jawbone. The first plurality of teeth can be embedded in a first gum or other tissue surrounding the first jawbone. A first gumline can be formed at the line separating the first gum from the exposed portions of the first plurality of teeth.

Similarly, the second jawbone further can comprise a second plurality of teeth extending from the second jawbone towards the first jawbone. The second plurality of teeth can be embedded in a second gum or other tissue surrounding the second jawbone. A second gumline can be formed at the line separating the second gum from the exposed portions of the second plurality of teeth.

As used in this application and in the claims, the term “mesial” refers to a portion of the tooth facing toward the front of the jawbone and a “distal” portion of an adjacent tooth. A mesial surface of the tooth can be substantially perpendicular to the lingual surface, the facial surface, and the occlusal surface of the tooth.

As used in this application and in the claims, the term “distal,” when used in connection with a tooth, refers to a portion of the tooth that faces the rear of the jawbone and is opposite the mesial portion of the tooth. A distal surface of the tooth can be opposite the mesial surface of the tooth and substantially perpendicular to the lingual surface, the facial surface, and the occlusal surface of the tooth. The mesial surface and the distal surface of the tooth can face or contact adjacent teeth.

As used in this application and in the claims, the term “occlusal” refers to portion of a tooth that contacts a tooth in another jawbone of the oral cavity. An occlusal surface, which can also be referred to as a chewing surface, can be a surface of the tooth disposed opposite a root of the tooth and towards a tooth in the other jawbone.

As used in this application and in the claims, the term “lingual” refers to a portion of a tooth closest to a tongue of the oral cavity. Thus, a “lingual surface” can be a surface of a tooth closest to the tongue. The lingual surface can also be referred to as an interior surface of the tooth.

As used in this application and in the claims, the term “facial” refers to a portion of a tooth closest to an ipsilateral cheek. Thus, a “facial surface” can be a surface of a tooth closest to the ipsilateral cheek or farthest from the tongue. The facial surface can also be referred to as an outside surface of the tooth.

As used in this application and in the claims, the terms “rinsing liquid,” “rinse water,” “fresh water,” or “water,” can refer to liquid injected into the oral cavity. The rinsing liquid can be used to irrigate the oral cavity and flush bacteria, plaque, food, saliva, toothpaste, and other detritus from the oral cavity. The rinsing liquid can comprise tap water or sterile water. In some examples, in lieu of or in addition to water, the rinsing liquid can comprise medication, supplements, mouthwash, antiseptics, or other additives to improve oral health.

As used in this application and in the claims, the term “discharge” or “discharge liquid” refers to a mixture of rinsing liquid and bacteria, plaque, food, saliva, toothpaste, and other detritus suctioned from the oral cavity.

### Overview of the Disclosed Technology

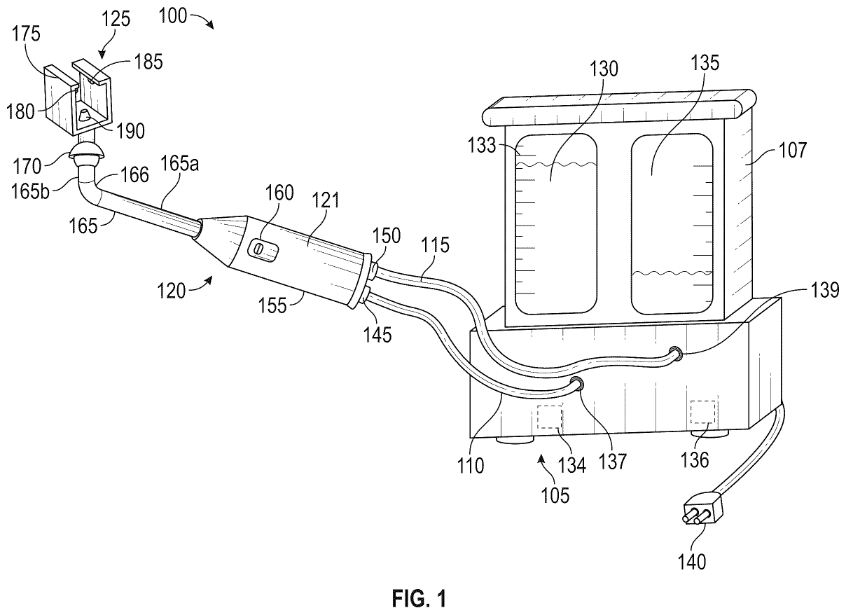

Referring now to FIG. 1, there is shown a dental cleaning apparatus 100, according to one example. The dental cleaning apparatus 100 can be configured to rinse toothpaste from a patient's oral cavity or otherwise clean teeth in the oral cavity by introducing a rinsing liquid into the oral cavity and then suctioning the rinsing liquid from the oral cavity. The dental cleaning apparatus 100 can comprise a base unit 105 configured to store rinsing liquid, a hand-held tool portion 120 configured to spray the rinsing liquid onto the teeth (and/or a gum in which the teeth are embedded) and suction discharge from a surface of the teeth (and/or a surface of the gum) or from the oral cavity, a supply conduit 110 (which is also referred to herein as a “rinsing-liquid supply conduit”) configured to carry rinsing liquid from the base unit 105 to the hand-held tool portion 120, and a suction conduit 115 configured to carry discharge from the hand-held tool portion 120 to the base unit 105. The tool portion 120 can comprise a handle 121 and a head 125 coupled to each other. However, other examples of the dental cleaning apparatus 100 can comprise additional or alternative components.

The base unit 105, which can also be referred to as a base or a base member, can be configured to store rinsing liquid for use by the dental cleaning apparatus 100. In some examples, the base unit 105 can additionally be configured to store discharge suctioned from a patient's oral cavity by the dental cleaning apparatus 100. In other examples, however, the discharge can be drained from the base unit 105 instead of stored in the base unit 105 after it is suctioned from the oral cavity. The base unit 105 can comprise a housing 107, a rinsing-liquid reservoir 130, a discharge reservoir 135, an outlet port 137, an inlet port 139, and a power source 140. However, other examples of the base unit 105 can comprise additional or alternative components.

The reservoir 130 can be configured to hold the rinsing liquid. The reservoir 130 can be an internal space formed within the housing 107, or a separate tank, a canister, or any suitable container disposed within the housing 107 and configured to store a liquid. In some examples, the container can be removable from the housing 107. In some examples, the housing 107 and/or the container can further comprise a removable or hinged lid or a cap to facilitate filling the reservoir 130 with the rinsing liquid.

In some examples, in which the dental cleaning apparatus 100 is configured to store the discharge suctioned from the oral cavity, the base unit 105 can comprise the discharge reservoir 135. The discharge reservoir 135 can be an internal spaced formed within the housing 107, or a separate a tank, canister, or other suitable container disposed within the housing and configured to hold the discharge suctioned from the oral cavity. In some examples, the housing 107 and/or the container can further comprise a removable or hinged lid or a cap to facilitate removal of the discharge and cleaning of the discharge reservoir 135.

The housing 107 can be formed from polymers, metal, glass, combinations thereof, or various other suitable materials. If the reservoirs 130, 135 are separate containers that are disposed in the housing, they also can be made from polymers, metal, glass, combinations thereof, or various other suitable materials. In some examples, the front portion of the housing 107 forming the reservoir 130 and/or the discharge reservoir 135 can include a transparent wall or window that allows a user to see the amount of contents held within the reservoirs. One or both transparent walls can comprise measurement lines 133 or other markings disposed along a vertical axis of the reservoir 130, 135 for displaying the volume of liquid therein.

The outlet port 137 can be configured to fluidly connect the rinsing-liquid supply conduit 110 to the base unit 105. The outlet port 137 can comprise a first end configured to be in fluid communication with the reservoir 130 and a second end configured to be in fluid communication with the rinsing-liquid supply conduit 110. In some examples, the outlet port 137 can be disposed on the base unit 105 beneath the reservoir 130. The outlet port 137 can comprise a snap connector, a screw connector, a hose barb, or any other suitable connector configured to form a watertight connection with the rinsing-liquid supply conduit 110.

In some examples, the outlet port 137 can further comprise a one-way valve (e.g., a check valve) disposed between the first end and the second end to prevent the rinsing liquid from backflowing from the conduit into the reservoir 130.

The base unit 105 can further comprise a supply pump 134 in fluid communication with the reservoir 130 and the outlet port 137. The supply pump 134 can be configured to propel rinsing liquid from the reservoir 130, through the outlet port 137, and to the head 125. The supply pump can be any suitable pumping mechanism, including but not limited to an electric pump. The pump can be housed within the base unit 105 below the reservoir 130.

The inlet port 139 can be configured to fluidly connect the suction conduit 115 to the base unit 105. The inlet port 139 can comprise a first end configured to be in fluid communication with the discharge reservoir 135 and at a second end configured to be in fluid communication with the suction conduit 115. In some examples, the inlet port 139 can be disposed on the base unit 105 beneath the discharge reservoir 135. The inlet port 139 can comprise a snap connector, a screw connector, a hose barb, or any other suitable connector configured to form a watertight connection with the suction conduit 115.

In some examples, the inlet port 139 can further comprise a one-way valve (e.g., a check valve) disposed between the second end and the first end to prevent the discharge from backflowing from the discharge reservoir 135 and into the suction conduit 115.

The base unit 105 can further comprise a suction or vacuum pump 136 in fluid communication with the discharge reservoir 135 and the inlet port 139. The suction pump 136 can be configured to create a pressure gradient for suctioning the discharge from the head 125, through the inlet port 139, and to the discharge reservoir 135. The suction pump 136 can be any suitable pumping mechanism, including but not limited to an electric pump. The suction pump 136 can be housed within the base unit 105 below the discharge reservoir 135.

The supply conduit 110 can be configured to carry the rinsing liquid from the base unit 105 to the handle 121. The supply conduit 110 can comprise a tube with a first end portion and a second end portion. The first end portion can be configured to be in fluid communication with the base unit 105. In some examples, the first end portion can be configured to connect to the outlet port 137, as described above. The second end portion can be configured to be in fluid communication with the handle 121. The supply conduit 110 can be formed from plastic, rubber, or any other suitable water-impermeable material. In some examples, the supply conduit 110 can comprise flexible medical tubing.

The suction conduit 115 can be configured to carry the discharge from the handle 121 to the base unit 105. The suction conduit 115 can comprise a tube with a first end portion and a second end portion. The first end portion can be configured to be in fluid communication with the base unit 105. In some examples, the first end portion can be configured to connect to the inlet port 139, as previously described. The second end portion can be in fluid communication with the handle 121. The suction conduit 115 can be formed from plastic, rubber, or any other suitable water-impermeable material, such as medical tubing.

In some examples, the dental cleaning apparatus 100 can establish a low-pressure environment within the suction conduit 115 to draw the discharge from the handle 121 to the base unit 105. Thus, in some of these examples, the suction conduit 115 can further comprise internal ribs or other reinforcing members to prevent the suction conduit 115 from collapsing on itself when the pressure inside the suction conduit 115 is lowered.

The power source 140 can be configured to provide electrical power to the dental cleaning apparatus 100, including the pumps 134, 136. In the illustrated example, the power source 140 can comprise a power supply with a power cord configured to receive electricity from a wall socket. However, in other examples, the power source 140 can comprise battery, a power supply unit, or any other suitable apparatus for supplying electrical power to the dental cleaning apparatus 100. For example, the base unit 105 can house replaceable and/or rechargeable batteries for providing electrical power to the apparatus.

The handle 121 can be configured to be held by a user of the dental cleaning apparatus 100. In some examples, the user of the dental cleaning apparatus 100 can be a patient whose mouth is being cleaned by the dental cleaning apparatus 100. In other examples, the user of the dental cleaning apparatus 100 can be a healthcare aide assisting the patient. The handle 121 can comprise a supply conduit connection or inlet port 145, a suction conduit connection or outlet port 150, a gripping portion 155, a user interface 160, an extension arm 165, and a pivot connection 170. However, other examples of the handle 121 can comprise additional or alternative components. For example, the handle 121 can alternatively include a fixed connection instead of the pivot connection 170, and the head 125 can be fixedly coupled to the handle 121 via the fixed connection (which can be similar to connection 170 but without the ability to pivot the head 125).

The handle 121 can comprise a cylindrical body extending along an axis formed between a first handle end portion and a second handle end portion. Although the handle 121 illustrated in FIG. 1 is cylindrical, it should be understood that other examples of the handle 121 can comprise non-cylindrical bodies of any suitable shape.

The inlet port 145 can be configured to fluidly connect the supply conduit 110 to the handle 121. The inlet port 145 can comprise a snap connector, a screw connector, a hose barb, or any other suitable connector configured to form a watertight connection with the supply conduit 110.

In some examples, the inlet port 145 can further comprise a one-way valve (e.g., a check valve) configured to prevent the rinsing liquid from backflowing from the handle 121 and into the supply conduit 110.

The outlet port 150 can be configured to fluidly connect the suction conduit 115 to the handle 121. The suction hose outlet port 145 can comprise a snap connector, a screw connector, a hose barb, or any other suitable connector configured to form a watertight connection with the suction conduit 115.

In some examples, the outlet port 150 can further comprise a one-way valve (e.g., a check valve) configured to prevent the discharge from backflowing from the suction conduit 115 and into the handle 121.

The tool portion 120 can comprise a rinsing-liquid supply conduit or channel that fluidly couples the supply conduit 110 to the head 125, thereby providing rinsing liquid from the supply conduit 110 to the head 125. The rinsing-liquid supply conduit can comprise, for example, a conduit (e.g., a tube) that extends through the extension arm 165 and the handle 121. A proximal end of the conduit can extend outwardly from the proximal end of the handle 121 and form the inlet port 145. The distal end of the conduit can be fluidly coupled to one or more spray nozzles 180, 185 of the head 125, as further described below. Alternatively, the extension arm 165 and the handle 121 can comprise an integrally formed internal channel that extends from the inlet port 145 to the head 125 for providing rinsing liquid from the supply conduit 110 to the spray nozzles 180, 185 of the head 125.

The tool portion 120 can comprise a discharge suction conduit or channel that fluidly couples the suction conduit 115 to the head 125, thereby providing discharge from the head 125 to the suction conduit 115. The discharge suction conduit can comprise, for example, a conduit (e.g., a tube) that extends through the extension arm 165 and the handle 121. A proximal end of the conduit can extend outwardly from the proximal end of the handle 121 and form the outlet port 150. The distal end of the conduit can be fluidly coupled to one or more suction nozzles 190 of the head, 125, as further described below. Alternatively, the extension arm 165 and the handle 121 can comprise an integrally formed internal channel that extends from the outlet port 150 to the head 125 for providing discharge from the suction nozzles 190 the head 125 to the suction conduit 115.

The gripping portion 155 can comprise an external surface of the handle 121 configured to be held by the user. The gripping portion 155 can further comprise ergonomic features (not pictured) that can beneficially help elderly, ill, or disabled users or users with limited physical ability hold the tool portion 120. The ergonomic features can include, for example, grooves, facets, bumps, ridges, ribs, finger holds, or other ergonomic features that help users with limited physical ability hold the dental cleaning apparatus.

The user interface 160 can be configured to control the operation of the dental cleaning apparatus 100. The user interface 160 can comprise a switch, dial, button, toggle, slider, touch screen, or other suitable control disposed on the handle 121. In some examples, the user interface 160 can be disposed on the handle 121 such that the user can operate the user interface 160 with a thumb, index finger, or other finger of the hand holding the handle 121.

In some examples, the user interface 160 can be configured to turn the dental cleaning apparatus 100 on or off. In particular, the user interface 160 can configured to actuate (turn on and off) each pump 134, 136 simultaneously or individually. In other examples, the user interface 160 can be configured to control a flow rate of the rinsing liquid or a suction rate of the discharge.

In other examples, the user interface 160 can be disposed on the base unit 105 instead of the head.

The extension arm 165 can be configured to support the head 125. The extension arm 165 can comprise an elongated body formed between a first arm end portion (a proximal end portion) 165a and a second arm end portion (a distal end portion) 165b. The first arm end portion 165a can be connected to a distal end of the handle 121. The second arm end portion 165b can be coupled to the head 125 and can include the pivot connection 170, having at least one degree of freedom that allows the head to move (e.g., pivot) relative to the handle.

As shown, the second end portion 165b of the extension arm 165 can comprise an angled bend 166. The angled bend 166 can comprise, for example, a 90-degree bend so as to position the head 125 at a 90-degree angle relative to the handle 121. However, the angled bend 166 can comprise any other suitable angle. Alternatively, the extension arm 165 can be substantially straight and thus lack the angled bend 166.

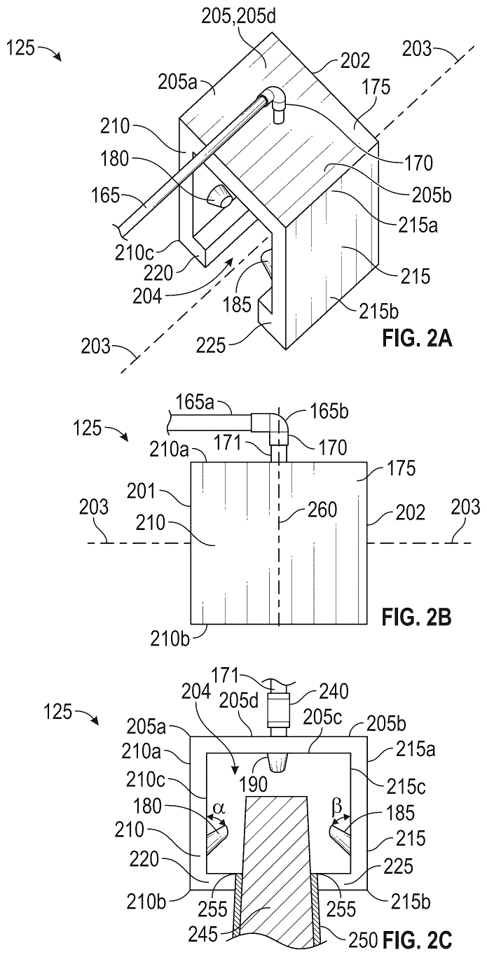

The pivot connection 170, which can also be referred to as a pivot joint, can be configured to rotatably couple the handle 121 to the head 125. Although the illustrated pivot connection 170 comprises a ball and socket joint, the pivot connection 170 can alternatively comprise a swivel joint, a universal joint, or any other suitable connection that allows the head 125 to rotate about one or more axes. The pivot connection 170 desirably is configured to permit at least pivoting movement of head 125 relative to the extension arm and the handle about a vertical axis 260 (FIG. 2B).

FIGS. 2A-2B show a simplified version of a pivot connection 170 comprising a 90-degree bend extending from the proximal portion 165a of the extension arm 165. A shaft 171 extends from the pivot connection 170 to the head 125. The shaft 171 is rotatable relative to the pivot connection 170, thereby allowing the head to rotate relative to the pivot connection. Each of the extension arm 165, the pivot connection 170, and the shaft 171 can include a rinsing-liquid supply conduit or channel and a discharge suction conduit or channel. The rinsing-liquid supply channels of the extension arm 165, the pivot connection 170, and the shaft 171 can be fluidly connected to each other and can be configured to supply rinsing liquid to the head 125. The discharge suction conduits or channels of the extension arm 165, the pivot connection 170, and the shaft 171 can be fluidly connected to each other and can be configured to carry discharge from the head 125. It should be noted that the extension arm 165, the pivot connection 170, and the shaft 171 (as well as the supply conduit/channel and the discharge conduit/channel extending through these components) can be larger than as illustrated to increase the flow of fluid into the mouth and/or increase the flow of discharge removed from the mouth.

FIGS. 2A-2C show the head 125 and its features in greater detail. As shown, the head 125 can comprise a body 175 (which can also be referred to as a “tooth engaging portion”), which can be configured to receive, engage, and/or at least partially enclose a tooth or a plurality of adjacent teeth. The head 125 can further comprise one or more nozzles, including a first nozzle 180, a second nozzle 185, and a third nozzle 190, wherein the nozzles can be configured to spray rinsing liquid onto the tooth or teeth (and/or a gum in which the tooth or teeth are embedded) and/or suction discharge from the oral cavity or from a surface of the tooth (and/or a surface of the gum). However, other examples of the head 125 can comprise additional or alternative components.

In some examples, the body 175 can be configured to at least partially enclose a tooth, teeth, or gum and substantially contain the rinsing liquid sprayed onto the tooth or teeth (and/or the gum) and the discharge generated by the cleaning within the body 175. For example, since the body 175 includes a lingual wall 210 that helps block the spray of rinsing liquid and discharge in the lingual direction and thus helps prevent the rinsing liquid and discharge from being sprayed further into the patient's oral cavity, the body 175 can beneficially prevent or at least minimize the possibility of a person from swallowing or choking on the rinsing liquid or the discharge.

The body 175 can comprise a mesial end 201 and a distal end 202. The mesial end 201 and the distal end 202 can form a mesial-distal axis 203 extending between the ends 201, 202.

The body 175 can form a C-shaped or a U-shaped cross section, wherein the cross-section is perpendicular to the mesial-distal axis 203. In some of these examples, the C-shaped or the U-shaped cross section can be substantially uniform along the mesial-distal axis 203. The tooth or teeth to be cleaned by the dental cleaning apparatus 100 can be aligned along the mesial-distal axis 203.

The mesial end 201 and distal end 202 can define openings of the body 175 that are in communication with an internal cavity 204. The openings can be sized to allow the tooth or teeth to enter one opening, pass through the internal cavity 204 and exit the opposite opening as the body 175 is moved along a row of teeth without lifting or repositioning the head, as further described below.

The body 175 can have a length extending along the mesial-distal axis 203 sufficient to receive one tooth within the internal cavity 204. In other examples, the body 175 can have a length sufficient to receive multiple teeth within the internal cavity 204 at once.

The body 175 is desirably formed from a water-impermeable material or substantially water-impermeable material to help contain the rinsing liquid and the discharge within the body 175. The body 175 can be formed from, for example, any of various polymers or elastomers, including natural rubber, or any of various synthetic elastomers (e.g., polyurethane, silicone rubber, nitrile rubber, butyl rubber, etc.). The body 175 desirably has sufficient elasticity and/or flexibility to facilitate positioning the body over a tooth and allow the body to be easily slid over a row of teeth while maintaining contact with the teeth or gums, as further described below. Advantageously, when formed of an elastomeric material, portions of the body 175 can conform to certain surfaces of the tooth and/or gum during use, as further described below.

The body 175 can comprise a first wall 205, a second wall 210, and a third wall 215. The first wall 205 can alternatively be referred to an occlusal wall or an occlusal portion since it can be disposed on an occlusal side of the tooth or teeth. The second wall 210 can alternatively be referred to a lingual wall or a lingual portion since it can be disposed on a lingual side of the tooth or teeth. The third wall 215 can alternatively be referred to a facial wall or a facial portion since it can be disposed on a facial side of the tooth or teeth.

The first wall 205 can enclose an occlusal side of the body 175. The first wall 205 can comprise a square or rectangular wall with a lingual end portion 205a and a facial end portion 205b. The first wall 205 can further comprise a first interior surface 205c, which can also be referred to as an interior occlusal surface, disposed on a side of the first wall 205 closest to the tooth or teeth. The first wall 205 can further comprise a first exterior surface 205d disposed on a side opposite the first interior surface 205c.

The first wall 205 can be mechanically coupled to the distal end portion 165b of the extension arm. For example, the distal end portion 165b can be coupled to an a central or an intermediate portion of the first exterior surface 205d.

The second wall 210 can enclose a lingual side of the body 175. The second wall 210 can comprise a square or rectangular wall with a first lingual wall end portion 210a and a second lingual wall end portion 210b. The second wall 210 can further comprise a second interior surface 210c, also referred to as an interior lingual surface, disposed on a side of the second wall 210 closest to the tooth or teeth.

The second wall 210 can be configured to extend from the first wall 205 to or below a gumline formed by the tooth/teeth and gums, thereby beneficially enclosing the exposed portions of the tooth/teeth and in some examples a portion of the gums, e.g., the gums in which the tooth/teeth are embedded.

The first lingual wall end portion 210a can be joined to the lingual end portion 205a of the first wall 205. As shown, the first lingual wall end portion 210a and the lingual end portion 205a of the first wall 205 are joined at a right angle.

The third wall 215 can enclose a facial side of the body 175. The third wall 215 can comprise a square or rectangular wall with a first facial wall end portion 215a and a second facial wall end portion 215b. The third wall 215 can further comprise a third interior surface 215c, which can also be referred to as an interior facial surface, disposed on a side of the third wall 215 closest to the tooth or teeth.

The third wall 215 can be configured to extend from the first wall 205 to or below a gumline formed by the tooth/teeth and gums, thereby beneficially enclosing the exposed portions of the tooth/teeth and in some examples a portion of the gums, e.g., a portion of the gums in which the tooth/teeth are embedded.

The first facial wall end portion 215a can be joined to the facial end portion 205b of the first wall 205. As shown, the first facial wall end portion 215a and the facial end portion 205b of the first wall 205 are joined at a right angle.

Now referring to FIG. 2B, there is shown a lingual side view of the head 125, according to one example. Although the figure illustrates the head 125 from the lingual side, the facial portion of the head 125 can look substantially similar because the lingual portion of the head 125 and the facial portion of the head 125 can be mirror images of each other.

Now referring to FIG. 2C, there is shown an end view of the head 125, according to one example, as viewed along the mesial-distal axis 203. As shown, the head 125 is positioned over a tooth 245 and gums 250. The tooth 245 and the gums 250 can form a gumline 255 where the tooth 245 and the gums 250 meet.

The body 175 can further comprise a first flange 220. The first flange 220, which can alternatively be referred to as a lingual flange, can extend from the first wall 205 towards the tooth 245, gums 250, and/or gumline 255. In the illustrated example, the first flange 220 can extend from the second lingual end portion 210b of the second wall 210 to the gumline 255, thereby minimizing the amount of rinsing liquid and/or discharge escaping the internal cavity 204 of the body 175. The illustrated first flange 220 extends from the second wall 210 at a right angle. However, other examples of the first flange 220 can extend from the second wall 210 at any suitable angle.

The body 175 can further comprise a second flange 225. The second flange 225, which can alternatively be referred to as a facial flange, can extend from the second wall 210 towards the tooth 245, gums 250, and/or gumline 255. In the illustrated example, the second flange 225 can extend from the second facial end portion 215b of the third wall 215 to the gumline 255, thereby minimizing the amount of rinsing liquid and/or discharge escaping the internal cavity 204 of the body 175. The illustrated second flange 225 extends from the third wall 215 at a right angle. However, other examples of the second flange 225 can extend from the third wall 215 at any suitable angle.

One or more nozzles can be located on one or more interior surfaces 205c, 210c, 215c of the body 175. For example, as best shown in FIG. 2C, the head 125 can comprise a first nozzle 180, a second nozzle 185, and a third nozzle 190. The nozzles can comprise any combination of spray nozzles configured to spray rinsing liquid onto the tooth 245 (and/or, in some examples, the gums 250 in which the tooth 245 is embedded) and suction nozzles configured to suction discharge from the oral cavity or from a surface of the tooth 245 (and/or, in some examples, a surface of the gums 250). However, it should be understood that the head 125 can comprise any suitable number of nozzles 180, 185, 190 in any suitable combination of spray nozzles and suction nozzles. In some examples, e.g., in which the patient is missing the tooth 245, the nozzles can be configured to spray rinsing liquid onto only the gums 250 and/or be configured to suction discharge from only a surface of the gums 250. Thus, it should be understood in the context of the present application that nozzles configured to spray rinsing liquid onto the tooth 245 and/or suction discharge from the surface of the tooth 245 can additionally or alternatively be used to spray rinsing liquid onto the gums 250 and/or suction discharge from the surface of the gums 250, e.g., the portion of the gums 250 in which the tooth 245 is embedded.

The first nozzle 180, the second nozzle 185, and the third nozzle 190 can comprise a nozzle shaped like a truncated cone. The truncated cone can be sufficiently short such that the nozzles 180, 185, 190 do not contact the tooth 245 and/or the gums 250. However, the nozzles 180, 185, 190 can have any suitable size or shape.

As shown, the first nozzle 180 can extend from the interior lingual surface 210c towards an adjacent lingual side of the tooth 245. The first nozzle 180 can extend from an intermediate or central portion of the interior lingual surface 210c between the first lingual wall end portion 210a and the second lingual wall end portion 210b. The first nozzle 180 can extend from the interior lingual surface 210c at a first nozzle angle (a). As shown, the first nozzle angle a can be less than 90 degrees. However, the first nozzle angle can be any suitable angle, including a right angle or an angle greater than 90 degrees. In some examples, the first nozzle 180 can extend toward a lingual side of the gums 250.

The second nozzle 185 can extend from the interior facial surface 215c towards an adjacent facial side of the tooth 245. The second nozzle 185 can extend from an intermediate or central portion of the interior facial surface 215c between the first facial wall end portion 215a and the second facial wall end portion 215b. The second nozzle 185 can extend from the interior facial surface 215c at a second nozzle angle (B). As shown, the second nozzle angle β can be less than 90 degrees. However, the second nozzle angle can be any suitable angle, including a right angle or an angle greater than 90 degrees. In some examples, the second nozzle 185 can extend toward a facial side of the gums 250.

The third nozzle 190 can extend from the interior occlusal surface 205c of the first wall 205 towards an adjacent occlusal surface of the tooth 245. As shown, the third nozzle 190 can extend perpendicularly from the interior occlusal surface 205c but can extend at any suitable angle in other examples.

Although FIG. 2C depicts one nozzle disposed on each of the interior surfaces 205c, 210c, 215c, it should be understood that the body 175 can comprise any suitable number of nozzles disposed in any suitable combination of the interior surfaces 205c, 210c, 215c. In some examples, multiple nozzles can be located on the same interior surface 205c, 210c, 215c of the body 175.

Further, any of the nozzles (e.g., nozzles 180, 185, 190) need not extend or protrude outwardly from the inner surfaces of the head, as shown in the figures. Instead, the nozzles can be contained entirely within the walls of the head such that the opening of each nozzle can be flush with the inner surface of the wall or recessed slightly within the wall. In this regard, such a nozzle can simply be an opening formed in an inner surface of a wall of the head that is in fluid communication with a conduit or channel extending through the head.

The first nozzle 180 located on the interior lingual surface 210c and/or the second nozzle 185 located on the interior facial surface 215c can comprise spray nozzles configured to clean a patient's tooth or teeth 245 and/or gums 250 by spraying rinsing liquid on the tooth or teeth 245 and/or the gums 250 to dislodge food, toothpaste, bacteria, and other detritus. Incorporating multiple spray nozzles on the head 125, especially when the spray nozzles are located on different interior surfaces of the body 175, can beneficially allow the dental cleaning apparatus 100 to rinse or clean multiple surfaces of the tooth 245 and/or the gums 250 at the same time. In other examples, in lieu or in addition to the spray nozzles on the interior lingual surface 210c and the interior facial surface 215c, one or more spray nozzles can be positioned on the interior surfaces 205c, 210c, 215c of the body 175.

The third nozzle 190 can be a suction nozzle configured to suction the discharge from the oral cavity. In other examples, in lieu or in addition to the suction nozzle on the interior occlusal surface 205c, one or more suction nozzles can be positioned on the interior surfaces 205c, 210c, 215c of the body 175.

The spray nozzles, e.g., the first and second nozzles 180, 185, can be in fluid communication with the rinsing-liquid supply conduit or channel of the extension arm 165 to receive rinsing liquid therefrom. For example, the body 175 can further comprise internal rinsing liquid channels or rinsing liquid conduits fluidly connected at respective ends to the first and second nozzles 180, 185 and to the rinsing-liquid supply conduit or channel of the extension arm 165. In this manner, rinsing liquid from the reservoir 130 can flow through the supply conduit 110, the conduit/channel in the handle 121 and the extension arm 165, the internal channels/conduits in the head 125 and outwardly from the first and second nozzles 180, 185. Additional or alternative spray nozzles can similarly be in fluid communication with the rinsing-liquid supply conduit or channel of the extension arm 165.

Similarly, the suction nozzles, e.g., the third nozzle 190, can be in fluid communication with the discharge suction conduit or channel of the extension arm 165. For example, the body 175 can further comprise internal discharge channel(s) or discharge conduit(s) fluidly connected at respective ends to the suction nozzle(s) 190 and to the discharge suction conduit or channel of the extension arm 165. In this manner, the discharge from the third nozzle(s) 190 can flow through the internal channels/conduits in the head 125, through the conduit/channel in the extension arm 165 and the handle 121, through the suction conduit 115, and into the discharge reservoir 135. Additional or alternative suction nozzles can similarly be in fluid communication with the discharge suction conduit or channel of the extension arm 165.

As shown in FIG. 2C, the head 125 can further comprise a connector 240 coupling the head 125 to the pivot connection 170. The connector 240 can allow the head 125 to be detached from the pivot connection 170, thereby beneficially allowing the head 125 to be disconnected from the dental cleaning apparatus 100 for cleaning or replacement. The connector 240 can be any suitable mechanical connector, including but not limited to a snap connector, a screw connector, and a press-fit connector. The connector 240 can include a rinsing-liquid supply conduit or channel to supply rinsing liquid to the head 125 and a discharge suction conduit or channel to carry discharge from the head 125.

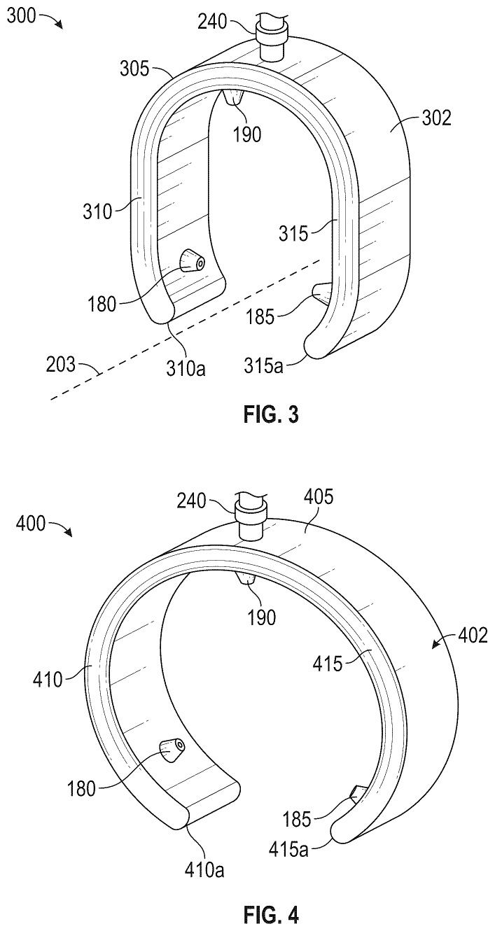

Referring now to FIG. 3, there is shown a head 300, according to another example, that can be used with the apparatus 100 in lieu of head 125. The head 300 can comprise a substantially elliptical body, or tooth-engaging portion, 302, a first nozzle 180, a second nozzle 185, a third nozzle 190, and the connector 240. However, other examples of the head 300 can comprise additional or alternative components. For example, any number of spray nozzles or suction nozzles can be positioned at various locations along the interior surface of the head 300.

The elliptical body 302 can have a substantially elliptical cross-section (except where an opening is formed at one end), wherein the cross-section is perpendicular to the mesial-distal axis 203. Thus, the cross-sectional profile of the elliptical body 302 can be referred to as an “open ellipse” or a “non-continuous ellipse.” The elliptical body 302 can comprise a first curved wall 305 (which can form an occlusal wall or occlusal portion of the head), a second curved wall 310 (which is also referred to herein as a “flange,” and which can form a lingual wall or a lingual portion of the head), and a third curved wall 315 (which is also referred to herein as a “flange,” and which can form a facial wall or a facial portion of the head), which can be connected to each other to form the elliptical body 302. The first curved wall 305, the second curved wall 310, and the third curved wall 315 can respectively enclose an occlusal, a lingual, and a facial side of the head 300. An end portion 310a of the second wall 310 can form a first flange and an end portion 315a of the third wall 315 can form a second flange, wherein the flanges are positioned to contact opposite sides of tooth/teeth and/or gums in use, as previously described for flanges 220, 225. The end portions 310a, 315a are spaced apart from each other to form a gap or opening therebetween for receiving at least one tooth (i.e., one tooth or a plurality of adjacent teeth) and in some examples a portion of the gum in which the at least one tooth is embedded.

Referring now to FIG. 4, there is shown a head 400, according to one example, that can be used with the apparatus 100 in lieu of the head 125. The head 400 can comprise a substantially circular or ring-shaped body, or tooth-engaging portion, 402, a first nozzle 180, a second nozzle 185, a third nozzle 190, and the connector 240. However, other examples of the head 400 can comprise additional or alternative components. For example, any number of spray nozzles or suction nozzles can be positioned at various locations along the interior surface of the head 400.

The circular body 402 can have a substantially circular cross-section (except where an opening is formed at one end), wherein the cross-section is perpendicular to the mesial-distal axis 203. Thus, the cross-sectional profile of the circular body 302 can be referred to as an “open circle” or a “non-continuous circle.” The circular body 402 can comprise a first rounded wall 405 (which can form an occlusal wall or occlusal portion of the head), a second rounded wall 410 (which is also referred to herein as a “flange,” and which can form a lingual wall or a lingual portion of the head), and a third rounded wall 415 (which is also referred to herein as a “flange,” and which can form a facial wall or a facial portion of the head), which can be connected to each other to form the substantially circular body 402. The first rounded wall 405, the second rounded wall 410, and the third rounded wall 415 can respectively enclose an occlusal, a lingual, and a facial side of the head 400. An end portion 410a of the second wall 410 can form a first flange and an end portion 415a of the third wall 415 can form a second flange, wherein the flanges are positioned to contact opposite sides of tooth/teeth and/or gums in use, as previously described for flanges 220, 225. The end portions 410a, 415a are spaced apart from each other to form a gap or opening therebetween for receiving at least one tooth (i.e., one tooth or a plurality of adjacent teeth) and in some examples at least a portion of the gums, e.g., the portion of the gums in which the at least one tooth is embedded.

In use, the head 125 (or head 300, 400) can be placed over a tooth, teeth, or gums (e.g., after brushing a patient's teeth with toothpaste) such that the flanges 220, 225 (or walls 310, 315, 410, 415) can contact opposite sides of the tooth/teeth and/or opposite sides of the gums. As shown in FIG. 2C, the flanges desirably can be placed just below the gum line 255 such that the entire exposed portion of the tooth/teeth above the gum line is positioned within the channel of the head and can be exposed to liquid from the spray nozzles 180, 185 and suction from the suction nozzle 190. As described above, the head desirably is formed from an elastomeric material. This allows the opposing side walls of the head to resiliently flex toward or away from each other and the flanges to come into contact with opposing sides of the gums as the head is placed over a tooth/teeth and/or the gums.

After placing the head over a tooth/teeth and/or the gums, the apparatus 100 can be turned on to begin spraying rinsing liquid onto the tooth/teeth and/or the gums via spray nozzles 180, 185, while simultaneously the discharge is drawn into the suction nozzle 190 and carried to the discharge reservoir 135. Alternatively, the apparatus 100 can be operated so as to spray rinsing liquid onto the tooth/teeth and/or the gums for a predetermined period of time (e.g., 1 or more seconds), and then discontinue the spraying of rinsing liquid while suctioning discharge. This cycle can be repeated after the head is moved to another tooth or teeth along a row of teeth and/or another gum. In some examples, the apparatus 100 can be operated so as to only spray rinsing liquid onto the tooth/teeth and/or the gums or to only suction discharge from the surface(s) of the tooth/teeth and/or the gums.

The handle 121 can be manipulated by the user to move the head along the row of teeth, successively rinsing and removing discharge from each successive tooth or set of teeth and/or portion of the gums that enters the channel of the head. As the head moves along the row of teeth and/or the gums, the head can pivot relative to the extension arm 165 around a vertical axis 260 at the pivot connection 170. Advantageously, this allows the user to move the head along an entire row of teeth (e.g., from a molar at one end of the row of teeth to another molar at the other end of the row of teeth) and/or along an entire portion of the gums, without removing and re-positioning the head from the teeth and/or the gums.

Since the width of the teeth and/or the gums (in the lingual-facial direction) can vary along a jawbone, the spacing or gap between the opposing flanges 220, 225 (or walls 310, 315, 410, 415) can be sized such that the flanges can always maintain contact with the opposing sides of the gums as the head is moved along a row of teeth and/or the gums. For example, the spacing between the flanges can be about the same or slightly smaller than the minimum tooth width along a row of teeth. As the head is moved along a row of teeth and/or the gums, the opposing walls of the head can flex or deform relative to each other, either increasing or decreasing the spacing between the flanges, depending on the width of the tooth/teeth and/or the gums presently within the channel of the head while the flanges can maintain contact with the gums due to the resiliency of the head.

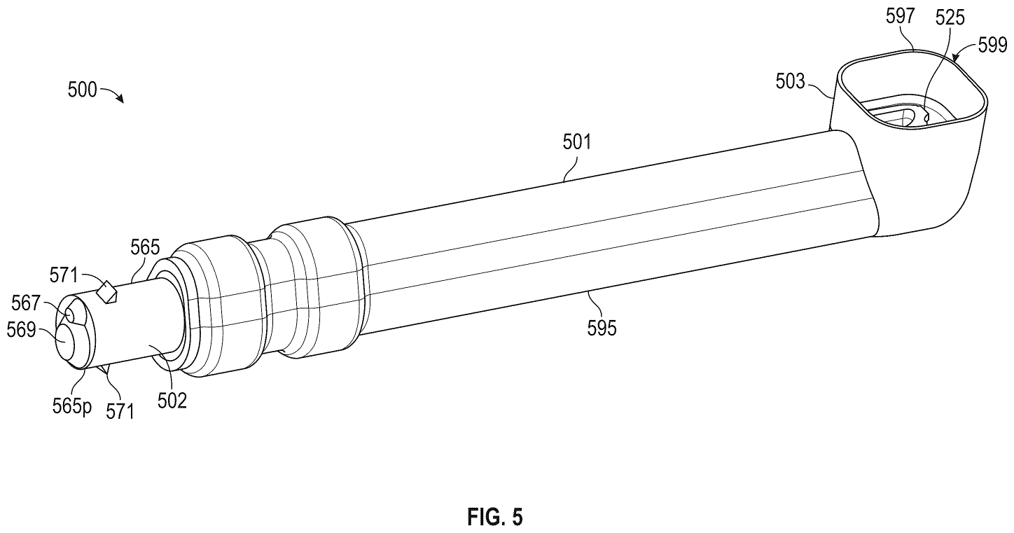

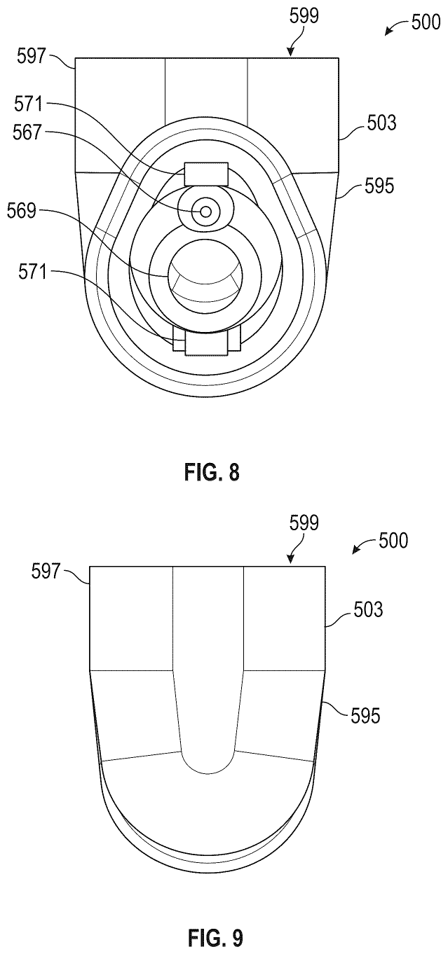

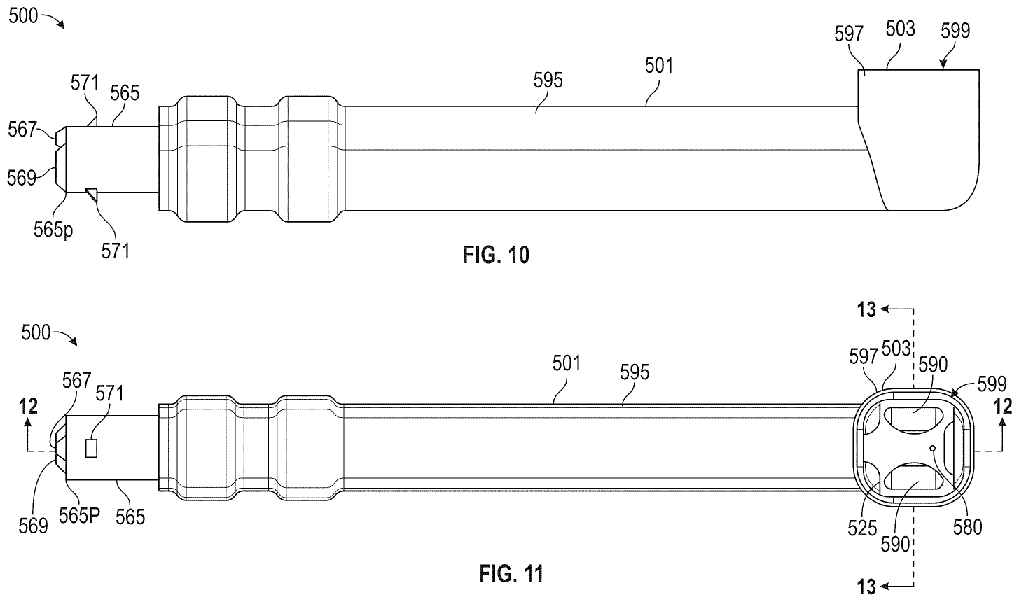

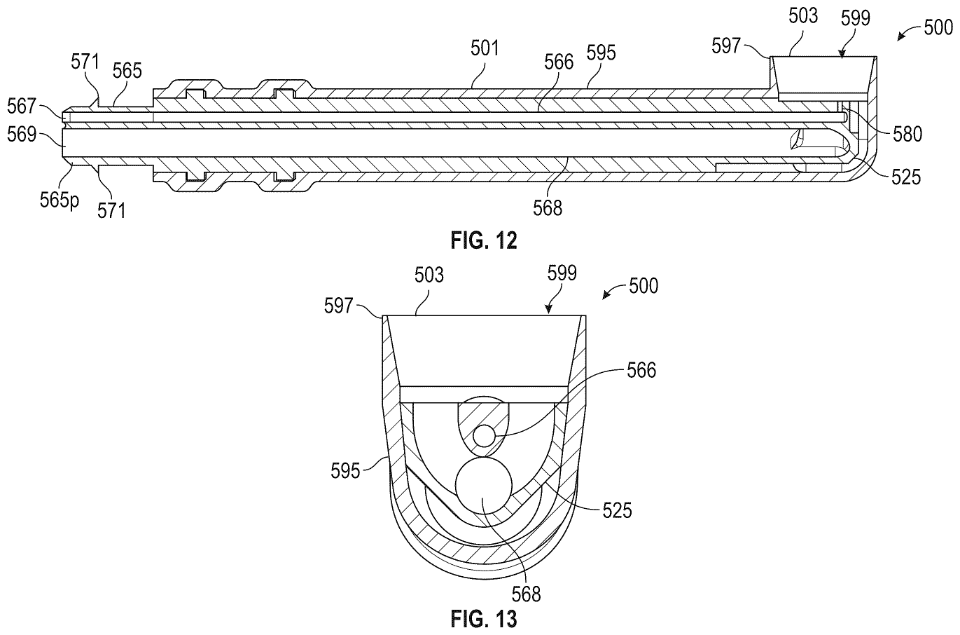

Referring now to FIGS. 5-13, there is shown a tool 500 (which is also referred to herein as a “tool portion”) of a dental cleaning apparatus, according to an example. As best shown in FIG. 5, the tool portion 500 can generally comprise a handle portion 501 (which is also referred to herein as an “extension portion” and/or an “extension portion/handle portion”) and a head portion 503 extending from a distal end of the handle portion 501. In some examples, the tool portion 500 can include an inner body 502 comprising an extension arm 565 and a distal end portion 525, and a casing 595 (also referred to herein as a sleeve or outer covering) covering a portion of the extension arm 565 and the distal end portion 525. Thus, in the example shown in FIG. 5, the extension portion/handle portion 501 can include the extension arm 565 and the portion of the casing 595 covering the extension arm 565, and the head portion 503 can include the distal end portion 525 and the portion of the casing 595 covering the distal end portion 525 (including a rim 597 formed by the casing 595, as further described below).

As shown, the head portion 503 is fixedly coupled to the extension portion/handle portion 501 such that the head portion 503 cannot pivot, move, or rotate relative to the extension portion/handle portion 501. In some examples, the head portion 503 can be configured to pivot or rotate relative to the handle portion 501.

In some examples, the tool portion 500 can be a component of a dental cleaning apparatus, such as the dental cleaning apparatus 100. Thus, in some examples, the dental cleaning apparatus 100 can include all of the components described above and shown in FIG. 1, except that the tool portion 500 can be connected to the handle 121 instead of the extension arm 165 and the head 125. In other examples, the extension portion/handle portion 501 can be used as a handle and can be fluidly coupled to the base unit 105 with one or more conduits without the use of a separate handle 121.

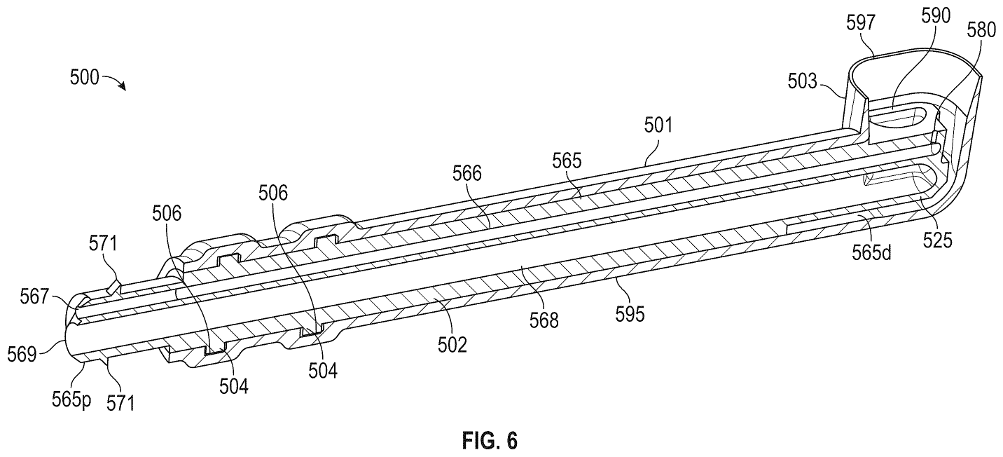

The extension arm 565 can include a proximal end portion 565p and a distal end portion 565d (FIG. 6). In some examples, the proximal end portion 565p of the extension arm 565 can be configured to be coupled to a separate handle (which in some examples can be similar to handle 121) of the dental cleaning apparatus 100. The distal end portion 565d of the extension arm 565 can terminate at the distal end portion 525 of the inner body 502. In some examples, the extension arm 565 can include one or more connectors 571 that can be configured to help detachably secure the extension arm 565 to another portion of the dental cleaning apparatus. As shown, the connectors 571 are two wedge-shaped protrusions extending laterally from the extension arm 565, but any other suitable types or shapes of connectors can be used.

In some examples where the tool portion 500 is coupled to a separate handle, the connectors 571 can be used to detachably secure the tool portion 500 to the handle.

In some examples, where the extension portion/handle portion 501 is used as a handle for gripping and manipulating the tool, the proximal end portion 565p can be fluidly coupled to the base unit 105 by a conduit (such as tubing) (not shown) that has a first end portion that fits over the proximal end portion 565p and optionally the connectors 571, and a second end portion that is connected to the base unit. The conduit can have two lumens, one of which can fluidly connect the inlet 567 and the outlet port 137 of the base unit 105, and the other of which can fluidly connect the outlet 569 and the inlet port 139 of the base unit 105. In some examples, the tool portion 500 can be fluidly connected to the base unit 105 with the supply conduit 110 and the suction conduit 115, for example, with the supply conduit 110 extending from the outlet port 137 to the inlet 567 and with the suction conduit 115 extending from the inlet port 139 to the outlet 569.

As best shown in FIG. 6, the extension arm 565 includes a rinsing liquid supply channel 566 (which is also referred to herein as a “rinsing liquid supply lumen”) and a suction discharge channel 568 (which is also referred to herein as a “suction discharge lumen”), each extending between the proximal end portion 565p and the distal end portion 565d of the extension arm 565. Alternatively, a liquid supply conduit and suction discharge conduit (e.g., two tubes) with respective liquid rinsing supply and suction discharge lumens can extend through the extension arm 565. A proximal end portion of the rinsing liquid supply channel 566 can form a rinsing liquid supply inlet 567. The rinsing liquid supply inlet 567 can be configured to be coupled to a corresponding rinsing liquid supply conduit of a separate handle or a lumen of a conduit that extends from the base unit 105 to the inlet 567 or a supply conduit 110 that extends from the base unit 105 to the inlet 567 in order to supply rinsing liquid to the head portion 503.

A proximal end portion of the suction discharge channel 568 can form a suction discharge outlet 569. The suction discharge outlet 569 can be configured to be coupled to a corresponding suction discharge conduit of a separate handle or a lumen of a conduit that extends from the base unit 105 to the outlet 569 or a discharge conduit 115 that extends from the base unit 105 to the suction discharge outlet 569 in order to carry suction discharge from the distal end portion 525.

As shown, the suction discharge channel 568 can have a wider diameter than the rinsing liquid supply channel 566 in order to accommodate discharge and other detritus suctioned from a subject's mouth. In some examples, the rinsing liquid supply channel 566 can have the same diameter as or a larger diameter than the suction discharge channel 568. In some examples, the extension arm 565 can be made from a rigid material (for example, metal or a rigid polymer, such a polyethylene, nylon or polycarbonate) in order to give the inner body 502 rigidity.

The head portion 503 includes at least one spray port 580 and at least one suction port 590 formed in the distal end portion 525 of the inner body 502. As best shown in FIG. 11, the distal end portion 525, which constitutes part of the head 503, includes two suction ports 590 and one spray port 580. A distal end portion of the rinsing liquid supply channel 566 can be fluidly coupled to the spray port 580. A distal end portion of the suction discharge channel 568 can be fluidly coupled to each suction port 590. Each one of the spray port 580 and the suction port 590 can be an aperture formed in the distal end portion 525. As shown, the suction port 590 can define a larger aperture in the distal end portion 525 than the spray port 580 in order to accommodate discharge and other detritus suctioned from the subject's mouth. In some examples, the aperture formed by one or both spray ports 580 can have the same diameter or a larger diameter than the aperture formed by the suction port 590. In some examples, the distal end portion 525 can be made from a rigid material (for example, metal or a rigid polymer, such a polyethylene, nylon or polycarbonate) in order to give the inner body 502 rigidity.

As shown, the spray port 580 and the suction port 590 are pointed in the same direction perpendicular to the length of the extension arm 565. In some examples, the spray port 580 and the suction port 590 can be angled relative to each other. In some examples, the spray port 580 and the suction port 590 can be angled at a non-perpendicular angle relative to the length of the extension arm 565.

As discussed above, the casing 595 can cover a portion (for example, a distal portion) of the inner body 502 (for example, at least a portion of the extension arm 565 and the entirety of the distal end portion 525) to form the extension portion/handle portion 501. In this way, the casing 595 can be configured to protect the extension arm 565 and the distal end portion 525 from damage. In some examples, the casing 595 can be formed from a rubbery or elastic material (for example, polyurethane, silicone rubber, nitrile rubber, butyl rubber, etc.) to enhance gripping of the handle portion 501 with a user's hand. In some examples, the casing 595, or at least the portion of the casing 595 covering the extension arm 565, can be optional, in which case the extension arm 565 alone can function as a handle. In some examples, the casing 595 can comprise multiple casing sections that are separate from each other, such as a first casing section covering the extension arm 565 and a second casing section covering the distal end portion 525. In some examples, the second casing section can include a rim 597, which is described below.

As further shown, the casing 595 forms a body or rim 597 of the head portion 503. The rim 597 is also referred to herein as a “sealing element” or a “sealing rim” or “tooth-engaging portion.” The rim 597 can be a flexible annular structure that can define an aperture 599 sized to fit a tooth (or at least a portion thereof) or more than one tooth (e.g., a plurality of adjacent teeth). The rim 597 can extend from the distal end portion 525 past the spray port 580 and the suction port 590 in a direction perpendicular to the length of the extension arm 565. Thus, the aperture 599 can open in a direction perpendicular to the length of the extension arm 565. The rim 597 can be configured to surround the tooth in order to create a seal around the portion of the tooth. In some examples, placing the rim 597 around the tooth (or the portion thereof) to create a seal therearound can help facilitate the suction of discharge or other detritus from the surface of the tooth and/or in the vicinity of the tooth. In some examples, the rim 597 can help further direct the spray of rinsing liquid exiting the spray port 580 and/or direct the flow of used rinsing liquid towards the suction port 590. In some examples, a plurality of bristles can be coupled to the distal end portion 525 and/or the rim 597. The rim 597 can be formed from a rubbery or elastic material (for example, polyurethane, silicone rubber, nitrile rubber, butyl rubber, etc.) in order to give it sufficient flexibility to deform around the tooth to create at least a partial seal against the surfaces of a tooth during use.

The rim 597 in the illustrated example has a rectangular cross-section profile (in a plane parallel to the aperture 599) and has four walls extending from the distal end portion 525. The walls can form a complete annular shape, although other shapes are possible. For example, the rim 597 can have other complete annular shapes in cross-section, such as a circle, oval, ellipse, etc. In use, the rim 597 therefore can engage the mesial, distal, lingual, and facial surfaces of a tooth, or at least four sides of a tooth where edges of the mesial, distal, lingual, and facial surfaces intersect the outer edges of the occlusal surface. In some examples, the rim 597 can have walls only on the lingual and facial sides of the rim; for example, the rim can have the same or similar shape as the bodies 175, 302, or 402.

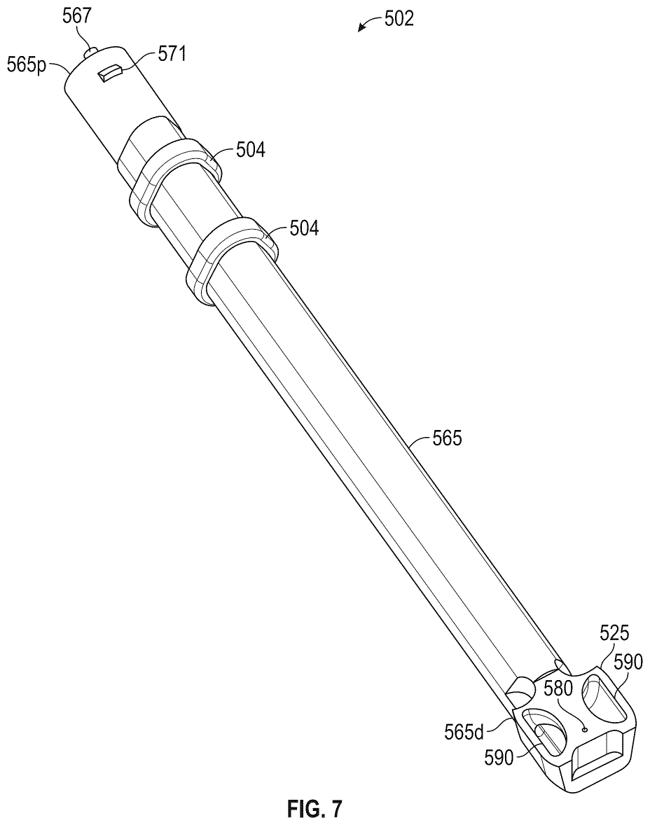

FIG. 7 shows the inner body 502 without the casing 595. As shown, the distal end portion 525 can include one spray port 580 disposed between two suction ports 590. In some examples, this arrangement of the spray port 580 and the suction ports 590 can help ensure that the rinsing liquid dispensed by the spray port 580 is collected by the suction ports 590. However, the distal end portion 525 can include any number of spray ports 580 and suction ports 590 in any arrangement. The extension arm 565 optionally can include one or more annular ridges or projections 504, which are received in annular grooves 506 in the casing 595. The projections 504 and grooves 506 can help maintain the position of the casing 595 on the extension arm 565.

Any of the example dental cleaning apparatuses (e.g., dental cleaning apparatus 100) and/or any portions thereof (e.g., heads 125, 300, 400, head portion 503, handle 121, handle portion 501, and/or tool portion 500) disclosed herein can be sized, shaped, or otherwise configured to clean the teeth and/or gums of a human subject, including a human adult or a human child. For example, any one of the heads 125, 300, 400, and head portion 503 can be sized or shaped to fit within the mouth of a human adult or human child and can be sized or shaped to be placed around or engage one or more permanent teeth (i.e., “adult teeth”) of a human adult and/or one or more relatively smaller primary teeth (i.e., “baby teeth”) of a human child, and/or the gums in which the teeth are embedded. In another example, the handle 121 and/or the handle portion 501 of the tool portion 500 can be sized or shaped to be gripped by a human adult or a relatively smaller human child.

Additionally or alternatively, any one of the example dental cleaning apparatuses disclosed herein and/or any portions thereof can sized, shaped, or otherwise configured to clean the teeth and/or gums of a non-human subject, including pets, livestock, or other non-human animals. For example, any one of the heads 125, 300, 400, and head portion 503 can be sized or shaped to fit within the mouth of and clean one or more teeth and/or gums of a dog, a cat, a rabbit, a horse, a cow, a sheep, a goat, a pig, and/or any other non-human animal with teeth. Thus, it should be understood that the dental cleaning apparatuses disclosed herein can be configured to be used on any suitable subject, including a human or a non-human animal.

### Additional Examples

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A dental cleaning apparatus can include a handle; and a head portion coupled to the handle. The head portion can include a body configured to be placed around at least one tooth and one or more spray ports or nozzles and one or more suction ports or nozzles coupled to or formed within the body.

Example 2. The dental cleaning apparatus of any preceding example, wherein the body can be configured to be placed around at least a portion of the gums.

Example 3. The dental cleaning apparatus of any preceding example, wherein the body can be configured to contain rinsing liquid and discharge within the body when placed around the at least one tooth.

Example 4. The dental cleaning apparatus of any preceding example, wherein the one or more spray ports or nozzles can be configured to spray rinsing liquid on the at least one tooth.

Example 5. The dental cleaning apparatus of any preceding example, wherein the one or more spray ports or nozzles can be configured to spray rinsing liquid onto the gums.

Example 6. The dental cleaning apparatus of any preceding example, wherein the one or more suction ports or nozzles can be configured to remove discharge from a surface of the at least one tooth.

Example 7. The dental cleaning apparatus of any preceding example, wherein the one or more spray ports or nozzles can be configured to remove discharge from a surface of the gums.

Example 8. The dental cleaning apparatus of any preceding example, wherein the body can be formed from an elastomer.

Example 9. The dental cleaning apparatus of any preceding example, wherein the head portion can be pivotably coupled to the handle.

Example 10. The dental cleaning apparatus of any preceding example, further comprising an extension arm extending from the handle to the head portion.

Example 11. The dental cleaning apparatus of any preceding example, wherein the extension arm can include a proximal portion extending from the handle, and a distal portion extending from the proximal portion to the head portion at an angle greater than zero relative to the proximal portion.

Example 12. The dental cleaning apparatus of any preceding example, wherein the distal portion can be substantially perpendicular to the proximal portion.

Example 13. The dental cleaning apparatus of any preceding example, wherein the distal portion can include a pivot connection configured to allow the head portion to pivot relative to the handle.

Example 14. The dental cleaning apparatus of any preceding example, which can further include a base unit with a supply reservoir and a discharge reservoir, a supply conduit configured to supply rinsing liquid from the supply reservoir to the handle, and a discharge conduit configured to supply discharge from the handle to the discharge reservoir.

Example 15. The dental cleaning apparatus of any preceding example, which can further include a pump configured to pump rinsing liquid from supply reservoir to the handle and the one or more spray ports or nozzles and a vacuum pump configured to draw discharge from the one or more suction ports or nozzles through handle to the discharge reservoir.

Example 16. A dental cleaning apparatus can include a handle portion and a head portion coupled to a distal end of the handle portion. The head portion can include a flexible body configured to enclose at least one tooth, a spray port or nozzle configured to spray rinsing liquid towards the at least one tooth, and a suction port or nozzle configured to draw discharge from the at least one tooth into the head portion.

Example 17. The dental cleaning apparatus of any preceding example, wherein the flexible body can include an internal cavity configured to accept the tooth.

Example 18. The dental cleaning apparatus of any preceding example, wherein the flexible body can further include a mesial end with a mesial opening and a distal end with a distal opening.

Example 19. The dental cleaning apparatus of any preceding example, wherein the mesial opening and the distal opening can be sized to allow the at least one tooth to enter one of the mesial opening or the distal opening, pass through the internal cavity, and exit the other of the mesial opening or the distal opening without repositioning the head portion.

Example 20. The dental cleaning apparatus of any preceding example, wherein the flexible body can be configured to enclose a plurality of adjacent teeth.

Example 21. A dental cleaning apparatus can include a handle portion, and a head portion coupled to a distal end of the handle portion. The head portion can include a body configured to accommodate a tooth, a spray port or nozzle extending from a first interior surface of the body, wherein the spray port or nozzle is configured to spray rinse water on the tooth; and a suction port or nozzle extending from a second interior surface of the body. The suction port or nozzle can be configured to suction discharge from a surface of the tooth. The dental cleaning apparatus can further include a base unit in fluid communication with the spray port or nozzle, wherein the base unit can be configured to pump rinsing liquid to the spray port or nozzle.

Example 22. The dental cleaning apparatus of any preceding example, wherein the head portion can further include an internal rinsing liquid conduit for fluidly connecting the spray port or nozzle and the base unit.

Example 23. The dental cleaning apparatus of any preceding example, wherein the head portion can further include a second spray port or nozzle extending from a third interior surface of the body.

Example 24. The dental cleaning apparatus of any preceding example, wherein the base unit can be configured to receive discharge from the suction port or nozzle and wherein the suction port or nozzle and the base unit can be in fluid communication.

Example 25. The dental cleaning apparatus of any preceding example, wherein the head portion can further include an internal discharge suction conduit for fluidly connecting the suction port or nozzle and the base unit.

Example 26. A head for a dental cleaning apparatus can include a flexible body configured to be placed around a tooth. The flexible body can include a first wall, a second wall joined to the first wall; and a third wall joined to the first wall. The dental cleaning apparatus can further include a first nozzle extending from an interior surface of the second wall and a second nozzle extending from an interior surface of the third wall.

Example 27. The head of any preceding example, wherein the first wall can include an occlusal wall, the second wall can include a lingual wall, and the third wall can include a facial wall.

Example 28. The head of any preceding example, wherein the head can further include a third nozzle extending from an interior surface of the first wall.

Example 29. The head of any preceding example, wherein the first nozzle and the second nozzle can be spray nozzles, and wherein the third nozzle can be a suction nozzle.

Example 30. The head of any preceding example, wherein the third nozzle can extend at a perpendicular angle from the interior surface of the first wall.

Example 31. The head of any preceding example, wherein the first nozzle and the first wall can form a first nozzle angle, and wherein the first nozzle angle can be less than 90 degrees.

Example 32. The head of any preceding example, wherein the second nozzle and the second wall can form a second nozzle angle, and wherein the second nozzle angle can be less than 90 degrees.

Example 33. The head of any preceding example, wherein the flexible body can have a rectangular cross-section.

Example 34. The head of any preceding example, wherein the flexible body can have an elliptical cross-section.

Example 35. The head of any preceding example, wherein the flexible body can have a circular cross-section.

Example 36. A dental cleaning apparatus can include a handle, a head portion coupled to the handle, wherein the head portion can include at least one spray port and at least one suction port, and a rim extending around the spray port and the suction port, wherein the rim can be an annular structure configured to be placed around at least a portion of a tooth.

Example 37. The dental cleaning apparatus of any preceding example, wherein the rim can define an aperture sized to accommodate at least the portion of the tooth.

Example 38. The dental cleaning apparatus of any preceding example, wherein the rim can extend in a direction perpendicular to a length of the handle.

Example 39. The dental cleaning apparatus of any preceding example, wherein the spray port and the suction port can be oriented in the direction perpendicular to the length of the handle.

Example 40. The dental cleaning apparatus of any preceding example, wherein the head portion can include one spray port and two suction ports.

Example 41. The dental cleaning apparatus of any preceding example, wherein the one spray port can be disposed between the two suction ports.

Example 42. The dental cleaning apparatus of any preceding example, wherein the at least one suction port can have a wider diameter than the at least one spray port.

Example 43. The dental cleaning apparatus of any preceding example, wherein the handle can include a rinsing liquid supply conduit fluidly connected to the at least one spray port, and wherein the extension arm can include a suction discharge conduit connected to the at least one suction port.

Example 44. The dental cleaning apparatus of any preceding example, wherein the rinsing liquid supply conduit can have a smaller diameter than the suction discharge conduit.

Example 45. The dental cleaning apparatus of any preceding example, wherein the rim can be formed from silicone.

Example 46. The dental cleaning apparatus of any preceding example, wherein the body is configured to be placed around at least one tooth of a human adult.

Example 47. The dental cleaning apparatus of any preceding example, wherein the body is configured to be placed around at least one tooth of a human child.

Example 48. The dental cleaning apparatus of any preceding example, wherein the body is configured to be placed around at least one tooth of a non-human animal.

Example 49. The dental cleaning apparatus of any preceding example, wherein the head portion is fixedly coupled to the handle.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as my invention all that comes within the scope and spirit of these claims.

1. A dental cleaning apparatus comprising:
a handle; and
a head portion coupled to the handle, wherein the head portion comprises:
a body configured to be placed around at least one tooth; and
one or more spray ports or spray nozzles and one or more suction ports or suction nozzles,
wherein the one or more spray ports or nozzles are configured to spray rinsing liquid on the at least one tooth, and
wherein the one or more suction ports or nozzles are configured to remove discharge from a surface of the at least one tooth.

2. The dental cleaning apparatus of claim 1, wherein the body is formed from an elastomer.

3. The dental cleaning apparatus of claim 1, wherein the head portion is fixedly coupled to the handle.

4. The dental cleaning apparatus of claim 1, further comprising an extension arm extending from the handle to the head portion.

5. The dental cleaning apparatus of claim 4, wherein the extension arm comprises a proximal portion extending from the handle, and a distal portion extending from the proximal portion to the head portion at an angle greater than zero relative to the proximal portion.

6. The dental cleaning apparatus of claim 5, wherein the distal portion is substantially perpendicular to the proximal portion.

7. The dental cleaning apparatus of claim 1, further comprising a base unit comprising a supply reservoir and a discharge reservoir, a supply conduit configured to supply rinsing liquid from the supply reservoir to the handle, and a suction conduit configured to supply discharge from the handle to the discharge reservoir.

8. A dental cleaning apparatus comprising:
a handle portion;
a head portion coupled to a distal end of the handle portion, wherein the head portion comprises:
a flexible body configured to at least partially enclose or engage at least one tooth;
a spray port or spray nozzle configured to spray rinsing liquid towards the at least one tooth; and
a suction port or suction nozzle configured to draw discharge from the at least one tooth into the head portion; and
a base unit in fluid communication with the spray port or spray nozzle and the suction port or suction nozzle.

9. The dental cleaning apparatus of claim 8, wherein the flexible body comprises an internal cavity configured to accept the tooth.

10. The dental cleaning apparatus of claim 9, wherein the flexible body further includes a mesial end comprising a mesial opening and a distal end comprising a distal opening.

11. The dental cleaning apparatus of claim 10, wherein the mesial opening and the distal opening are sized to allow the at least one tooth to enter one of the mesial opening or the distal opening, pass through the internal cavity, and exit the other of the mesial opening or the distal opening without repositioning the head portion.

12. The dental cleaning apparatus of claim 8, wherein the flexible body is configured to at least partially enclose or engage a plurality of adjacent teeth.

13. A dental cleaning apparatus comprising:
a handle portion;
a head portion coupled to the handle portion, wherein the head portion comprises at least one spray port and at least one suction port; and
a rim extending around the spray port and the suction port, wherein the rim is an annular structure configured to be placed around at least a portion of a tooth.

14. The dental cleaning apparatus of claim 13, wherein the rim defines an aperture sized to accommodate at least the portion of the tooth.

15. The dental cleaning apparatus of claim 14, wherein the rim extends in a direction perpendicular to a length of the handle portion.

16. The dental cleaning apparatus of claim 13, wherein the at least one suction port has a wider diameter than the at least one spray port.

17. The dental cleaning apparatus of claim 13, wherein the handle portion comprises a rinsing liquid supply channel in fluid communication with the at least one spray port and a suction discharge channel in fluid communication with the at least one suction port.

18. The dental cleaning apparatus of claim 13, wherein the rim comprises an elastomer.

19. The dental cleaning apparatus of claim 13, further comprising:
an inner body comprising an extension arm and a distal end portion comprising the at least one spray port and the at least one suction port; and
an elastomeric outer casing comprising a first portion and a second portion, wherein the first portion of the outer casing extends at least partially over the extension arm to form the handle portion and the second portion of the outer casing extends over the distal end portion to form the head portion.

20. The dental cleaning apparatus of claim 19, wherein the second portion of the outer casing extends beyond the distal end portion of the inner body to form the rim.
